(19) United States
(12) Patent Application Publication
(10) Pub. No.: US 2014/0188677 A1
(43) Pub. Date: Jul. 3, 2014

(54) KNOW YOUR CUSTOMER EXCHANGE SYSTEM AND METHOD

(71) Applicant: IDENTRUST, INC., San Francisco, CA (US)

(72) Inventors: Vishvas PATEL, Sandy, UT (US); Karen J. WENDEL, San Francisco, CA (US)

(73) Assignee: IDENTRUST, INC., San Francisco, CA (US)

(21) Appl. No.: 14/139,351

(22) Filed: Dec. 23, 2013

Related U.S. Application Data
(60) Provisional application No. 61/746,803, filed on Dec. 28, 2012.

(51) Int. Cl. G06Q 40/02

(52) U.S. Cl. CPC G06Q 40/02
USPC 705/35

(57) ABSTRACT

The systems and methods described herein attempt to overcome the drawbacks discussed above by providing a know your customer (KYC) exchange system and method that allows for easy transmission of corporate and individual identification information to a selected financial institution. The KYC exchange system, which may be implemented by a bank, a corporation, or other party, receives as an input the laws and practicalities of a plurality of nations and regions, as well as KYC business policies of a plurality of financial institutions located across the plurality of nations and regions. Using the collected input information, the system is able to provide feedback to individuals and corporations using the exchange system regarding whether the individual or corporation has provided all of the requested and necessary identification and financial services information.

### CROSS-REFERENCE TO RELATED APPLICATIONS

The subject matter disclosed herein claims priority to U.S. Provisional Application Ser. No. 61/746,803, filed Dec. 28, 2012, entitled “Know Your Customer Exchange System and Method,” which is incorporated by reference in its entirety.

### TECHNICAL FIELD

The present invention relates generally to information gathering and providing, and more specifically, to systems and methods for gathering identity information for account applications.

### BACKGROUND

Financial institutions, such as banks, are regulated by many complex laws in America and internationally. In particular, financial institutions must meet the legal requirements to know your customer (KYC). KYC requires financial institutions to perform a certain amount of customer identification verification, which varies from country-to-country and region-by-region, before conducting financial business with their customers. KYC generally requires financial institutions to collect basic identity information, and may include more stringent requirements, such as determining a customer's risk in terms of their propensity to commit money laundering or identity theft. The extent of the identification and background checking depends on a country's KYC laws.

The KYC requirements may generate several problems for individuals, corporations, and financial institutions. As discussed above, KYC laws vary from country to country, and also vary across political divisions within a country. For example, the KYC requirements of one state in the United States may be different than the KYC requirements of another state in the United States. The KYC laws also get interpreted by regulators to generate rules and regulations, or “practicalities.” Financial Institutions also interpret the laws to create KYC business processes in order to comply the KYC laws and practicalities. As with any law, KYC laws and practicalities are subject to change, and a financial institution must remain constantly abreast to changes to the KYC laws and practicalities. Reviewing and remaining informed of KYC laws may be difficult and time consuming for a financial institution.

As KYC laws may vary greatly across political divisions, financial institutions may elect to try to comply with as many nations' KYC requirements as possible with a single KYC business practice. Rather than generating dozens of different KYC processes for each of the regions that a financial institution operates within, a financial institution may elect to implement one, very extensive KYC process that meets the requirements of as many of the different laws as possible. If a first financial institution employs an extensive KYC business process, a customer may find that the first financial institution requires much more documentation and private information than another financial institution. Not only is a customer likely to be confused as to why the first financial institution is requiring so much information, but the customer may also lose trust in the first financial institution for its lack of transparency in explaining the law and process.

While a financial institution must receive some personal/private information to comply with KYC, an individual likely does not want to provide the financial institution with any more personal/private information than is necessary to receive the financial service. The same approach likely applies to a corporation. As part of a corporate financial service application, a corporation may need to provide individual identity information (like a passport or a social security number) of a high-ranking employee, such as a treasurer or a president. A corporation likely prefers to limit the number of employees who must give up personal/private information because the private information may be difficult to quickly obtain and the corporation has an incentive to protect its employees. Without knowing the laws and practicalities, a corporation may be willingly, unknowingly, and needlessly giving up more personal/private employee information than is necessary. It benefits the corporation and its employees to avoid such a needless transmission of private information.

Further still, international corporations do not like repeatedly performing similar KYC processes for the same or similar financial services provided in a different nation or region. A multi-national corporation may need dozens of bank accounts in a plurality of different countries and regions, and each application process may require the gathering and transmitting of both corporate and individual identification information. A company may be able to file all of this information in a secure location, but each time a new financial service is desired, copies must be made, application forms must be completed, and the information must be sent to another financial institution. As a result, the KYC laws and regulations create a burden for the corporations providing identification information.

In view of all of the above discussed limitations and problems, a method for secure, fast, and convenient KYC and financial services information transmission and provision is desired for individuals, corporations, and financial institutions.

### SUMMARY

The systems and methods described herein attempt to overcome the drawbacks discussed above by providing a know your customer (KYC) exchange system and method that allows for easy transmission of corporate and individual identification information to a selected financial institution. The KYC exchange system, which may be implemented by a bank, a corporation, or other party, receives as an input the laws and practicalities of a plurality of nations and regions, as well as KYC business policies of a plurality of financial institutions located across the plurality of nations and regions. Using the collected input information, the system is able to provide feedback to individuals and corporations using the exchange system regarding whether the individual or corporation has provided all of the requested and necessary identification and financial services information.

In one embodiment, a computer implemented method for initiating a financial service at a financial institution comprises receiving, by a computer, a request from a client computer for a financial service associated with a financial institution, wherein the request comprises a selection of a country and a selection of the financial institution; determining, by the computer, one or more know your customer (KYC) requirements associated with the selected financial institution; determining, by the computer, one or more country requirements that are associated with the selected country; determining, by the computer, whether a set at least one documents stored in a corporate vault memory satisfies the one or more KYC requirements, and whether the set of at least one documents satisfies the one or more country requirements; calculating, by the computer, an extent to which the set of at least one documents satisfies the one or more KYC requirements and the one or more country requirements; and presenting, by the computer, for each selected financial institution in each selected country, an indicator of the extent to which the at least one documents satisfies the one or more KYC requirements and the one or more country requirements.

In another embodiment, a system for preparing documents for a financial service comprises a know your customer (KYC) requirements repository storing one or more KYC requirements associated one or more financial institutions; a country requirements repository storing one or more country requirements associated with one or more countries; a corporate vault memory storing one or more packages and one or more documents, wherein each package comprises a set of one or more documents selected from the one or more documents stored in the corporate vault memory; a client computer transmitting a request for a financial service associated with a package, wherein the request comprises a selection of a country and a selection of a financial institution; an exchange server processor receiving the request and configured to calculate a completion score based on an extent to which the package satisfies the one or more KYC requirements associated with the selected financial institution and the one or more country requirements associated with the selected country, wherein the package is a complete package when the completion score indicates that the package satisfies all requirements.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a system diagram of communicating devices according to an exemplary embodiment.

FIG. 2 illustrates a flow diagram of a method of creating, reviewing, and submitting a KYC package according to an exemplary embodiment.

FIG. 3 illustrates a screen shot of a home page according to an exemplary embodiment.

FIG. 4 illustrates a screen shot of a web page showing applicable laws of a country according to an exemplary embodiment.

FIG. 5 illustrates a screen shot of a web page showing applicable practicalities for opening a bank account in a country according to an exemplary embodiment.

FIG. 6 illustrates a screen shot of a corporate vault and all documents uploaded to the corporate vault according to an exemplary embodiment.

FIG. 7 illustrates a screen shot of a KYC package creation page according to an exemplary embodiment.

FIG. 8 illustrates a screen shot of a web page displaying required documents necessary to open an account at a selected branch according to an exemplary embodiment.

FIG. 9 illustrates a screen shot of a summary page illustrating missing and uploaded documents necessary to open an account at a selected branch according to an exemplary embodiment.

FIG. 10 illustrates a screen shot of an option to upload missing documents according to an exemplary embodiment.

FIG. 11 illustrates a screen shot of an option to name a KYC package and set an expiration date for the KYC package according to an exemplary embodiment.

FIG. 12 illustrates a screen shot of a web page listing potential KYC package reviewers according to an exemplary embodiment.

FIG. 13 illustrates a screen shot of a digital signature feature according to an exemplary embodiment.

FIG. 14 illustrates a screen shot of a status page for existing KYC packs according to an exemplary embodiment.

FIG. 15 illustrates a screen shot of a status page for approved KYC packs according to an exemplary embodiment.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments that may be substituted for the particular examples described herein and still fall within the scope of the invention.

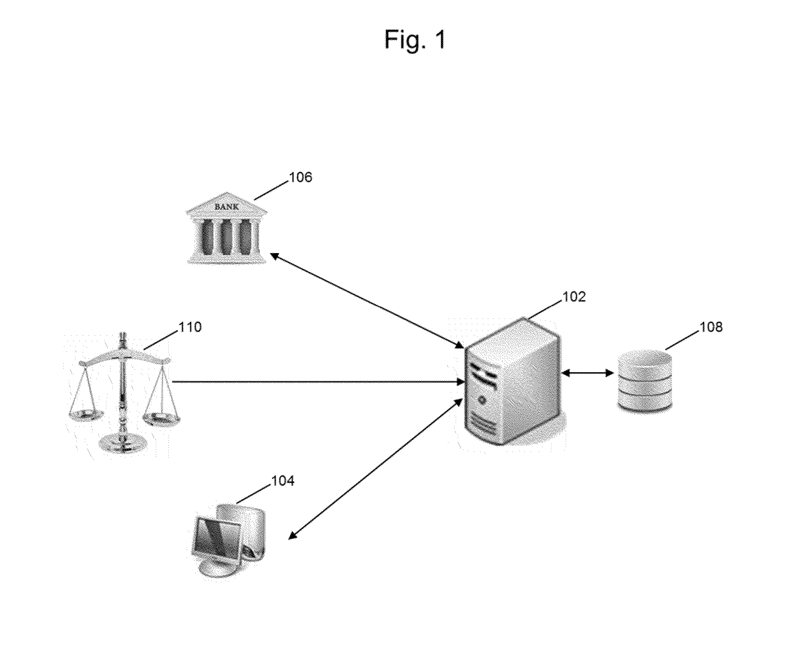

Referring to FIG. 1, a KYC exchange server 102 communicates with a client computer or server 104, a financial institution 106, and a database 108.

The client computer 104 of a customer, such as an individual or corporation, or a financial institution 106, may implement the use of the KYC exchange server 102 capabilities in their KYC processes. The KYC exchange server 102 may be any type of server capable of receiving and responding to requests from a plurality of client devices over a network, such as a LAN, WAN, WLAN, or the like.

In the exemplary embodiment, the KYC exchange server 102 is a web server that receives requests and sends messages over the Internet. The KYC exchange server 102 can transmit information to be displayed on a graphical user interface (GUI), such as information transmitted over the internet to be displayed on a web browser of the client computer 104. The database 108 may store information sent from the financial institution 106 and the client computer 104. Non-limiting examples of a database 108 may include an SQL, an OQL, or an XQuery, database. The database may store the KYC business practices of the financial institution 106 and identification documents sent from the client computer 104. Further still, the database 108 may store KYC laws, rules, and regulations 110 of a plurality of countries. The rules and regulations may be created by government agencies interpreting and enforcing KYC laws within a certain country. The database 108 may be periodically updated as laws and practicalities change and as financial institutions and client computers provide new and updated information.

The database 108 may be implemented as a software as a service model that stores all personal and corporate identification information, and the database 108 allows a company or to an individual to access, update, create, and delete identification information on the database 108. Because some users may be apprehensive about supplying their identification information on an unknown sever, some users may be given the option to store their identification on at a local computer device, for example, a server under the control of a corporation where the user is employed.

The financial institution 106 may be connected to the KYC exchange server 102 through a client computer device or a server owned and operated by the financial institution 106. The financial institution 106 may provide the KYC exchange server 102 with its KYC business practices as an input, and the KYC business practices may be updated whenever the financial institution 106 changes their KYC policies.

Alternatively, the KYC exchange server 102 may upload the KYC business practices of the financial institution 106 by determining the financial institution's practices through alternative methods. For example, a company that hosts the KYC exchange server 102 may receive the financial institution's 106 KYC business practices through an agreement between the company hosting the KYC exchange server 102 and the financial institution 106.

Alternatively, the company may collect data by interviewing customers of the financial institution 106. The financial institution's 106 KYC business practices may be attained by a plurality of different ways, but no matter how the information is collected, the financial institution's 106 business practices can be used as an input to the KYC exchange server 102. The KYC exchange 102 server can use the KYC business practices to provide feedback to customers about whether the customers have provided a complete KYC package according to the business practices of the financial institution 106.

The client computer 104 may be a personal computer, a mobile phone, a tablet, or any other computer device capable of securely connecting to the KYC exchange server 102 and may be used by a potential customer who wishes to open an account with the financial institution 106. While the client computer 104 is described as a client computer, it should be noted that the computer 104 may be any computer device capable of networked communication including host computers and servers.

The client computer 104 may be controlled by an individual seeking to open a personal account or by an employee at a corporation seeking to open a corporate account on behalf of the corporation. In either situation, the user controlling the client computer 104 uploads identification information to the KYC exchange server 102 to be saved on the database 108. The user of the client computer 104 may upload personal identification information and corporate identification information. The user of the client computer 104 also uses the uploaded identification information to create a KYC package to send to the financial institution 106.

The communication connection, which may be a network or Internet connection, between the KYC exchange server 102 and the client computer 104 and the communication connection between the KYC exchange server 102 and the financial institution 106 may be a very secure connection protocol, such as HTTPS, (SSH), FTPS, SCP or any other secure network protocol. In addition, connecting to the KYC exchange server from the financial institution 106 or the client computer 104 may require very strong user credentials, such as a digital smart card based digital certificate, a USB based digital token, or any other secure credentials. The strong credentials may be implemented in addition to a user name, a password, and a PIN. Strong credentials and strong data security are required because personal identification information is being sent through the network.

While one financial institution 106 and one client computer are illustrated as being connected to the KYC exchange server 102, the KYC exchange server 102 is capable of communicating with a plurality of financial institutions and a plurality of client computer devices. Since the KYC exchange server 102 is intended to store KYC requirements for financial institutions located around the world, many financial institutions and client computers from around the world may be connected to the KYC exchange server 102.

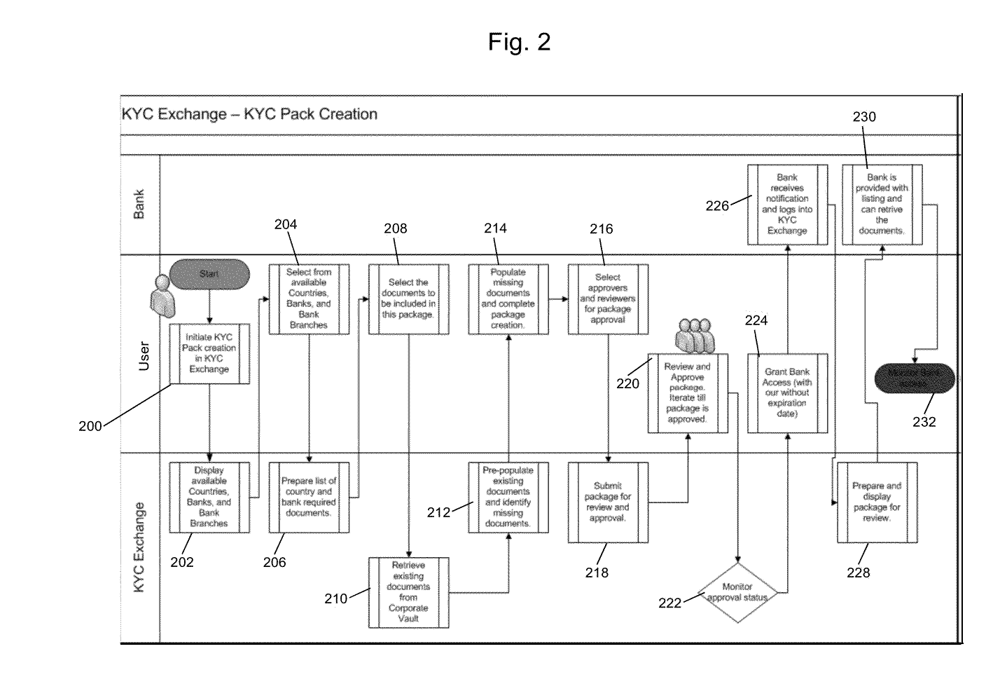

Referring now to FIG. 2, a method of creating a KYC package to be submitted to a financial institution as part of a KYC verification processes is illustrated. After the method starts, in step 200, a user, who may be an individual or an employee of a corporation, initiates the KYC package creation by sending a message to the KYC exchange server. The initiation step represented by step 200 may include a user log-in step. The user log-in step may prompt the user to enter a username, a password, and specify a digital certificate. A digital certificate may be required in addition to a username and password. As described above, a heightened level of security is required because personal identification information may be submitted to the KYC exchange server once connected.

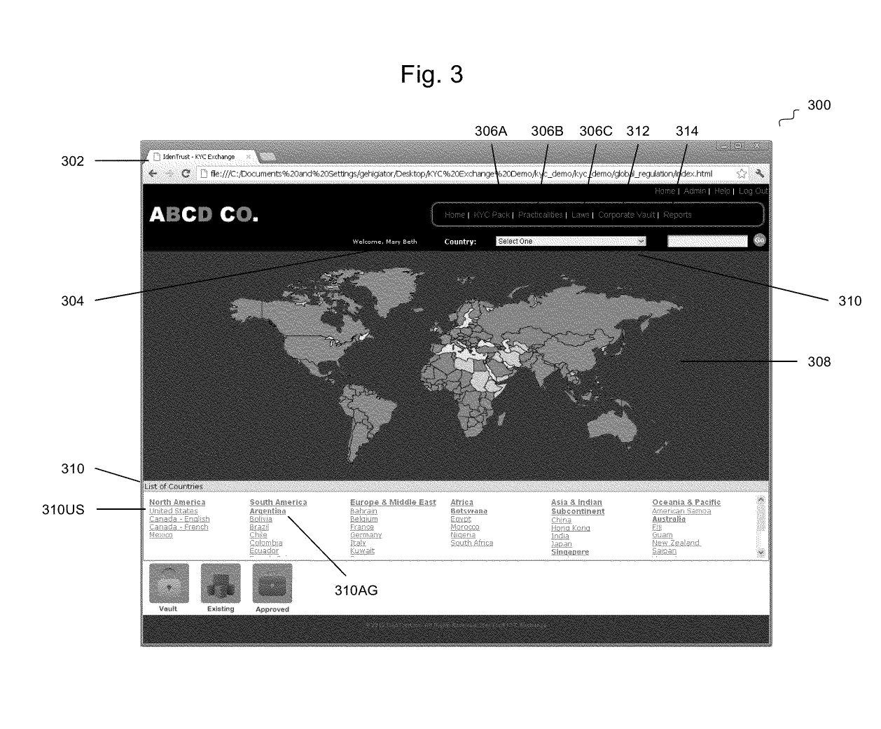

After the user is logged in, in step 202, the KYC exchange server may display available countries, financial institutions, and financial institution branches. The KYC exchange server may first illustrate all of the supported countries, which may be similar to FIG. 3. As illustrated in FIG. 3, a map feature is shown, and the user can click on any country shown on the map. As another method of finding a certain country, the user can click on a country name listed in the list of countries. The list of countries may be grouped geographically, such as according to continents. An alphabetical list of countries may also be included, and the alphabetical list may be accessed by clicking a drop-down menu. As yet another alternative, the user may be able to search for a country using a search box.

FIG. 3 illustrates a screen shot of a main page, or “home page,” according to an exemplary embodiment of the GUI hosted on a webserver as a website.

On the main page, if the user is part of a corporation, the corporation's logo 302 or the company's name may be listed on of the screen 302. Also, the user's name 304 who is accessing the KYC server may be listed and welcomed. As shown in FIG. 3, the exemplary user name 304 “Mary Beth” is displayed.

The home page may provide links 306 for Laws 306A, Practicalities 306B, and KYC Package creation 306C. These three links 306 interact with the world map 308 and the list of countries 310. To view any laws 306A or practicalities 306B, the user must also select a country 310US either before or after selecting the laws 306A or practicalities 306B. Also, direct links 314 for a corporate vault and reports are provided.

If the user clicks the laws link 306A, and also selects a country, for example, Argentina 306AG, the KYC exchange server provides a webpage showing applicable laws for the selected country.

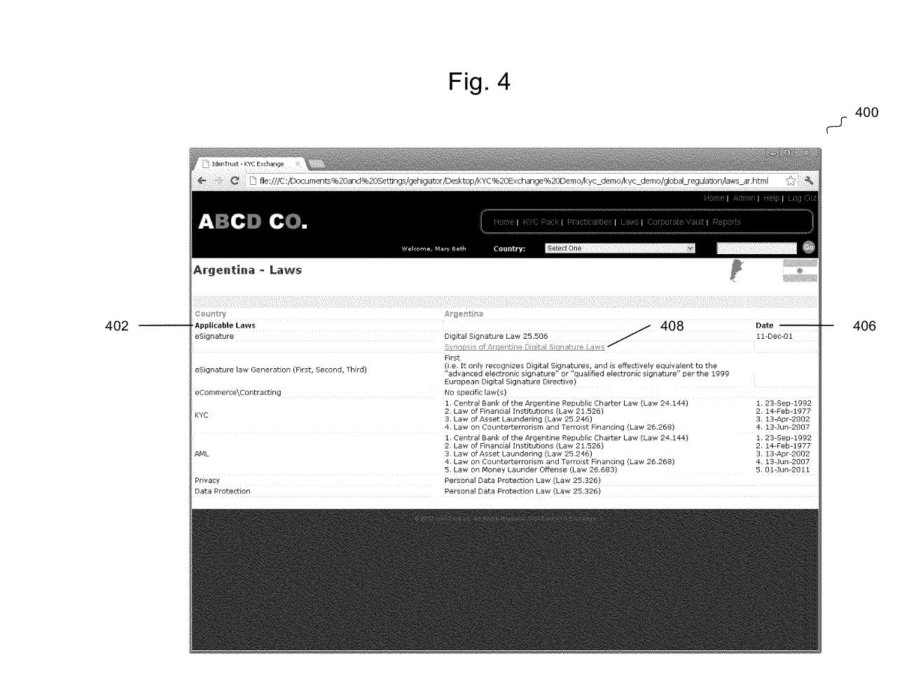

The laws webpage for Argentina 400 is illustrated in FIG. 4. The applicable laws 402, which may be laws dealing with KYC, are listed according to category. The date that the law was inducted may also be listed 406. Each law may also include a link 408 to the country's government website from which the information is collected.

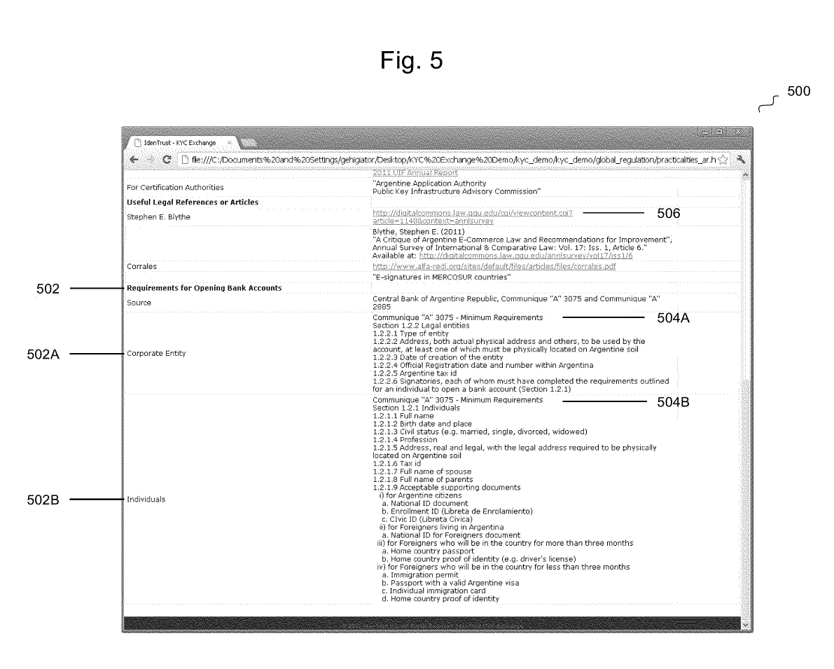

If the user clicks the practicalities link 306B and also selects a country (e.g., Argentina 306AG), the KYC exchange server provides a webpage showing applicable rules and regulations for the selected country, show in FIG. 5.

The practicalities webpage 500 for Argentina is illustrated in FIG. 5, where exemplary requirements 502 for opening a bank account for individuals 502B and corporations 502A are illustrated. In this exemplary embodiment, the practicalities webpage 500 shows all of the identification documents necessary for a corporate entity 504A or an individual 504B to open a bank account in Argentina. Links may also be provided to the source of the listed information 506, such as a link to a government agency's webpage that interpreted the laws and created the rules and regulations. The laws and practicalities web pages 400, 500 are informational, and allow the user to decide if a financial institution is requesting a reasonable amount of information for KYC compliance.

Returning to FIG. 3, if the user clicks the corporate vault link 312, the KYC exchange server provides a webpage showing the information that has been uploaded to the corporate vault.

The corporate vault is a secure location on the database where all of the personal identification information about the individual or corporation is stored. The corporate vault may be stored on a database within a datacenter of a company running the KYC exchange server. All of the personal and corporate identification information may be stored on the database and accessed through the corporate vault.

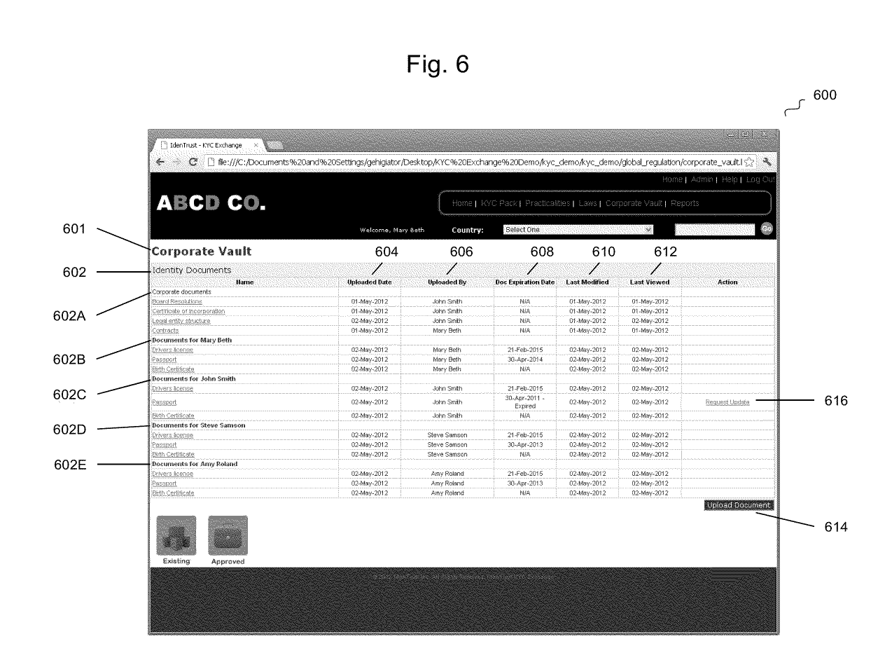

FIG. 6 illustrates the corporate vault 601 webpage 600. As shown in FIG. 6, the documents 602 may be grouped together according to what entity or person the documents identify. For example, corporate documents 602A may be grouped together, and personal documents 602B-E of each individual employee may also be grouped together. A plurality of other information about the history of the document are also included, such as the upload date 604 of the documents, which user uploaded the documents 606, the document's expiration date 608, the document's last modification date 610, and when the document was last viewed 612.

The corporate vault 601 can be configured so that not all users can see every document listed 602 in the corporate vault 601 based upon privileges assigned to the users. For example, FIG. 6 shows that John Smith's 602C passport has been uploaded to the corporate vault 601. If the user does not have the necessary privileges, the personal information of John Smith 602C may be hidden from the user. The user may still be able to submit John Smith's 602C passport as part of a KYC package creation process, but the user may not be able to view John Smith's 602C personal information without the necessary privileges.

More documents may be uploaded by clicking the upload document button 614. Clicking the upload document button 614 may open a file directory manager so that the user can find the file path and upload the document to the database. Uploaded documents can be clicked on and previewed if the user has the necessary privileges.

If a document is out of date, the user may request an update 616 from the person holding the document. For example, in FIG. 6, John Smith's 602C passport has expired, so the user may request an update by pressing the request update 616. When requesting an update, the system sends John Smith a notification that his passport is out of date and requests that he submit a non-expired copy of the document to the database.

Returning again to FIG. 3, if the user clicks the reports link 314, the KYC exchange server provides a webpage showing generated reports and tools to generate new reports. The reports may be a description of all of the activity of the user with the KYC exchange server, such as package creation, KYC package submission, KYC package approval, and document upload and update history, etc. Dates, times, and results may all be reported through these reports. For example, every KYC package ever created may be reported. As another example, the user may wish to create a report listing all the KYC packages created and sent to a certain bank. In such a case, all of the created KYC packages may be filtered so that only KYC packages sent to the selected bank are displayed in the report. The reports may be filtered by many options like creation date, expiration date, name, creator username, reviewer username, etc.

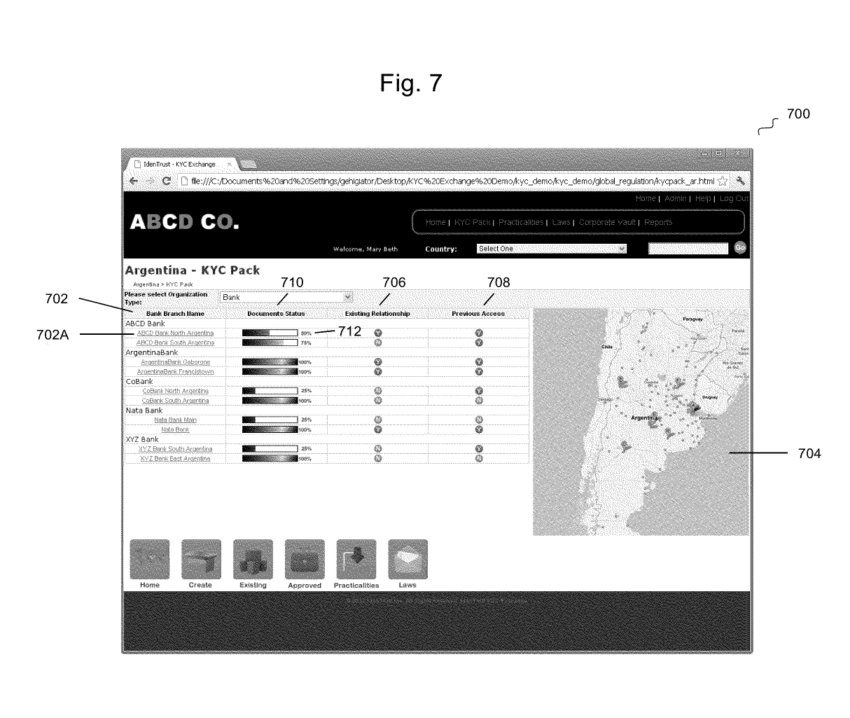

Returning to FIG. 2, in step 204 the user selects the KYC package link and selects from available countries where the user would like to open an account, which may be accomplished on the home page 300 illustrated in FIG. 3. After clicking on a country 310, the user may be brought to a page by the KYC exchange server that lists, for example, all of the banks and bank branches within the selected country in step 206. For example, if the user selects Argentina 310AG, a page 700 similar to the page illustrated in FIG. 7 may be generated by the KYC exchange server.

As shown in FIG. 7, a plurality of branches 702 may be listed according to bank companies and regions of the selected country. Also, a map 704 may be included showing the locations of the branches within the selected country, which in this example is Argentina. A desired branch may be selected using the map feature as well.

Additional information may be presented to the user, such as whether a preexisting relationship 706 with the financial institution has been established. Also, documents status indicator 710 displays an indication (e.g., as a percentage) that can inform the user if the user currently has all or just a portion of the branch's required documents in the corporate vault. The KYC server may reference the KYC requirements for each branch and compare the required documents with the documents uploaded to the corporate vault. If all of the required documents are included in the corporate vault, the KYC exchange server reports that one-hundred percent of the documents have been uploaded. If less than one-hundred percent of the required documents are in the corporate vault, the KYC exchange server reports the percentage of required documents that are included in the corporate vault. If less than one-hundred percent are included, the user may continue, and upload additional documents to meet the requirements of the branch later, or the user may submit less than the required amount according to the financial institution's KYC policies.

Due to political, geographic, or other boundary divisions, a first branch of a first financial institution in a first region may have different KYC requirements than a second branch of the first financial institution in a second region. Also, due to different interpretations of the laws of the country, the first financial institution may have different KYC requirements than a second financial institution. These differences are reflected in the percentage bars 712 displayed to the user. Thus, the user may use the information presented in choosing one financial institution or one branch over another.

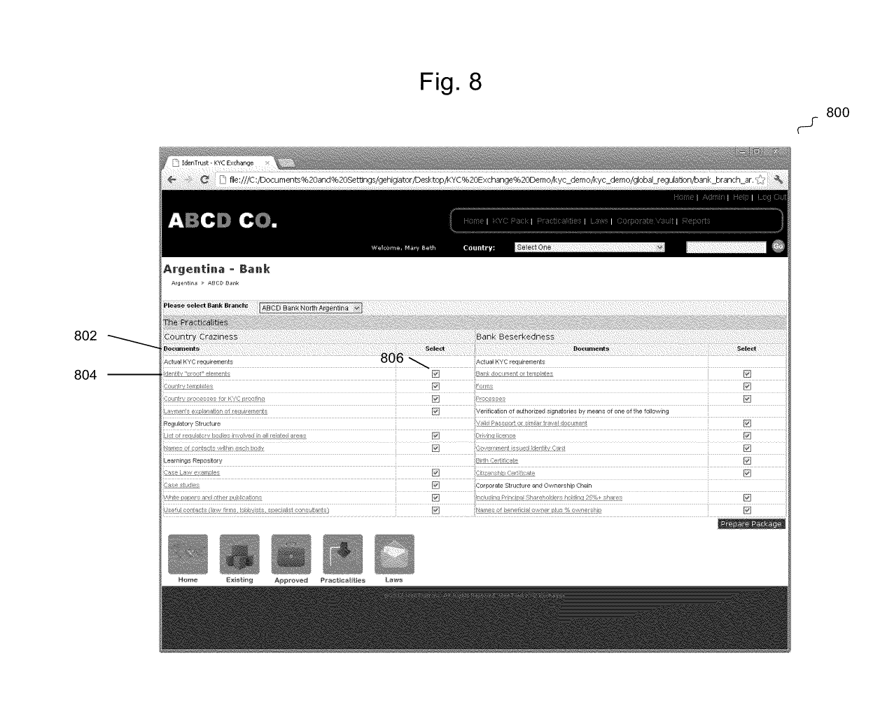

After the user selects a branch 702A from the list of branches 702, the user selects the documents to be included in a KYC package. The documents selection web page 800 is illustrated in FIG. 8.

As shown in FIG. 8, the KYC exchange server generates the required documents 802 from the country perspective and the financial institution perspective. Each type of document has a link 804, which explains what the document is and why it is required. Also, next to each document is a checkbox 806, and the checkbox allows the user to decide which documents are going to be included in the KYC package. A financial institution may later request the additional documents, but the user may decide not to submit the documents required by the laws or the financial institution at this time.

After the user selects which documents to include, the KYC exchange server retrieves existing documents from the corporate vault, which is stored on the database, in step 210. After retrieving all of the documents in the corporate vault from the database, the KYC exchange server pre-populates existing documents and identifies missing documents in step 212.

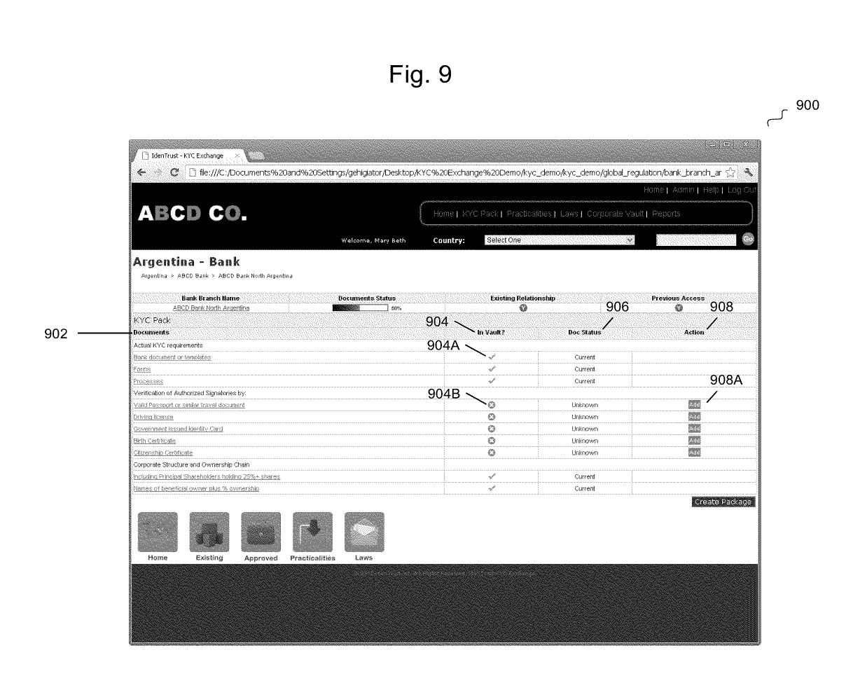

In step 212, the KYC exchange server identifies all of the documents specified by the user in step 208 and compares these documents to the documents already uploaded to the corporate vault. Any documents in the corporate vault that match a category selected by the user are flagged for inclusion in the KYC package, and missing documents are notified to the user. This process can be illustrated by FIG. 9.

As shown in FIG. 9, documents that have been already uploaded to the corporate vault 904 are marked with a check 904A. Any missing documents are marked with an “X”904B, and an action button 908 appears that allows the user to add the missing documents without leaving this web page 900. If the user does not have immediate access to any of the missing documents, the user can save the KYC package creation progress and finish the KYC package creation at a later time. If the user has access to the missing documents, the user can click the “Add” button 908A, find the document on a storage device, and upload the documents.

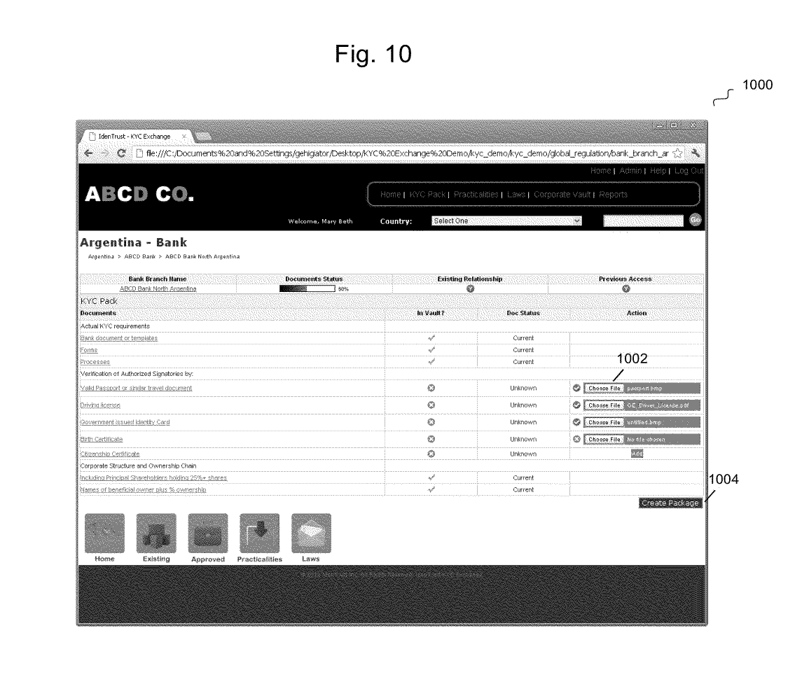

As shown in FIG. 10, after clicking the “Add” button 908A, a “Choose File” button 1002 appears. The choose file button 1002 allows the user to find a file on a connected storage device to upload to the KYC exchange server. The choose file button 1002 may bring up a file directory manager so that the user can find a file on the storage device.

In step 214, missing documents are populated and the package creation is completed. Once all of the files are populated and uploaded to the database, the user can create the KYC package by selecting the “Create Package” button 1004.

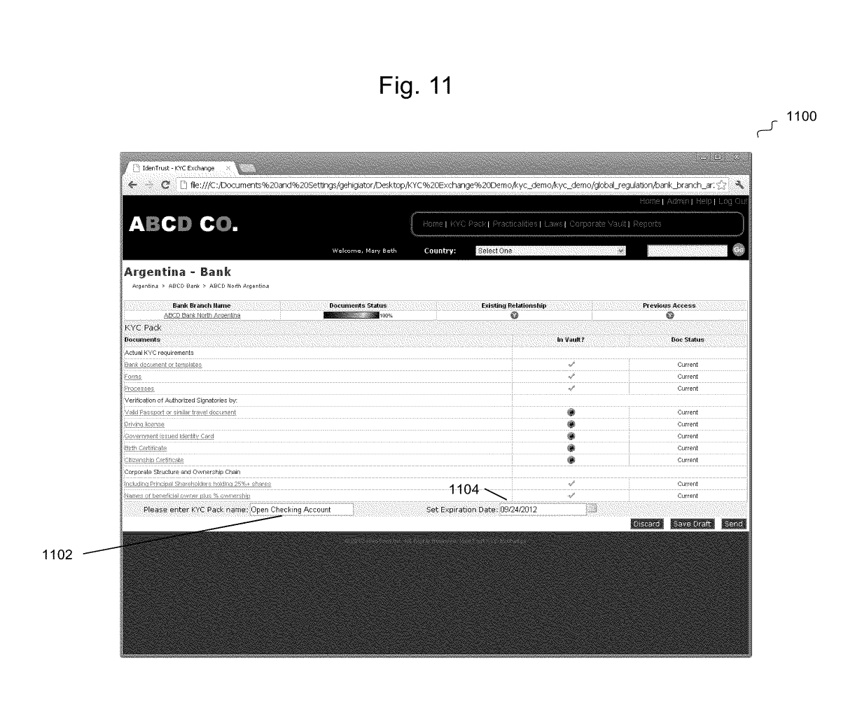

As shown in FIG. 11, the user can name the KYC package 1102 and set an expiration date 1104 for the package. The expiration date 1104 prevents a financial institution or any third party from viewing the created KYC package after the expiration date 1104. An expiration date 1104 does not delete the KYC package, and the created KYC package may remain visible to internal users. Also, the expired KYC package may be renewed and sent to another financial institution or the same financial institution.

After creating a package, the user can select a reviewer from a list of reviewers to review the KYC package in step 216 before it is submitted to the branch. Because the KYC package includes private information about individuals and corporations, an internal review is performed before submitting the KYC package to any third parties. Reviewers may be high level employees at a corporation. If the user is an individual, the reviewer is also the user, so the reviewer selection step may be omitted in the case of an individual applying for an account at the branch.

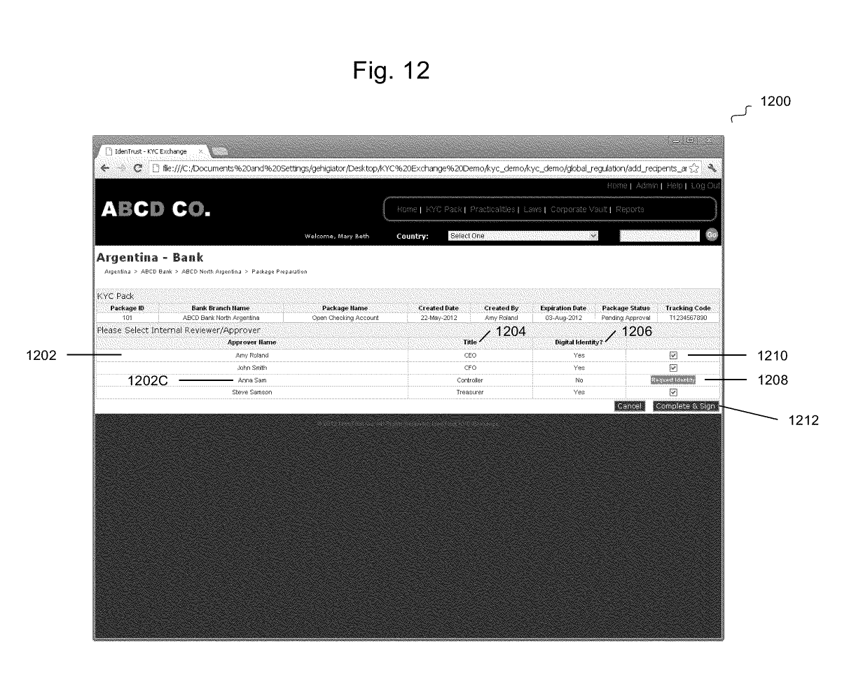

The reviewer selection step 216 is illustrated further in FIG. 12. As shown in FIG. 12, for example, four qualified reviewers 1202 and their title 1204 are listed, and the user can select one or all of them to review the KYC package for submission to the branch. Only reviewers with an up-to-date digital identity 1206 can approve KYC packages, thus the user cannot select Anna Sam 1202C for approval. The user can request that Anna Sam obtain a digital identity 1206 by clicking the “Request Identity” button 1208. By pressing the request identity button 1208, Anna Sam receives a notification, for example, in the form of an email, requesting her to obtain a digital identity 1206 so that she may approve KYC packages created through the KYC exchange server. Once a digital identity 1206 is obtained by Anna Sam, a check box 1210 would appear by her name and she may approve KYC packages. The KYC package is submitted to the KYC exchange server once the user clicks the “Complete and Sign” button 1212.

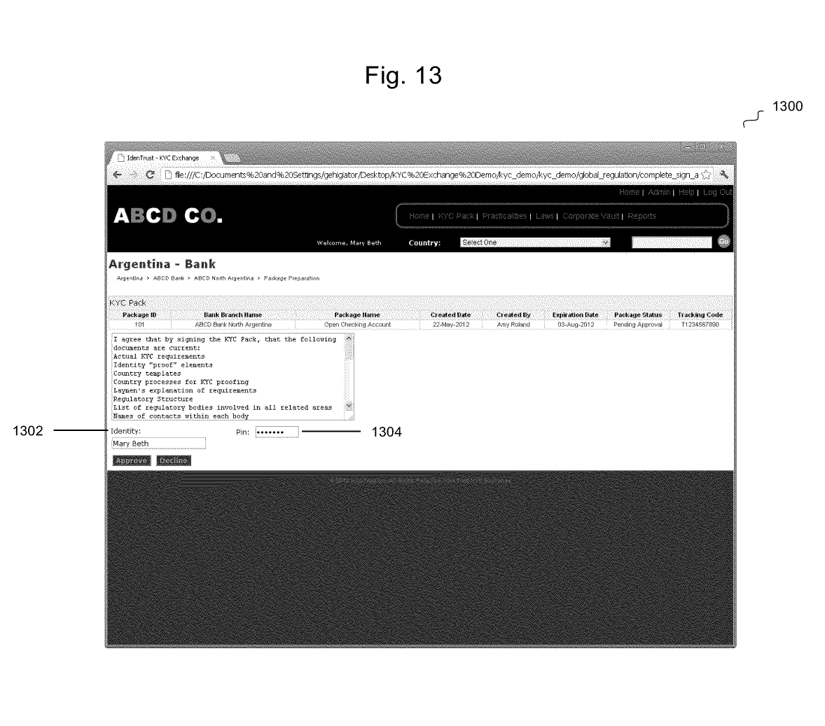

FIG. 13 illustrates an exemplary digital signature web page 1300. The user may digitally sign the KYC package with an identity 1302 and a PIN 1304. The digital signing may include further security features such as an audible signature. Once the KYC package has been digitally signed, the reviewers who were selected for approval are notified that a KYC package is pending their approval. The creator of the KYC package may also receive a notification that they have created a KYC package, and this notification may further include a tracking number of the created KYC package. The KYC exchange server iterates until the package is approved.

Returning to FIG. 2, in step 220, the selected reviewers review the KYC package and approve it for transmission to the financial institution. In some embodiments, the KYC exchange server may send a notification to the KYC package creator when a KYC package is approved by a reviewer.

In step 222, the KYC exchange server monitors for approval status waiting for the KYC package creator to grant access to the branch.

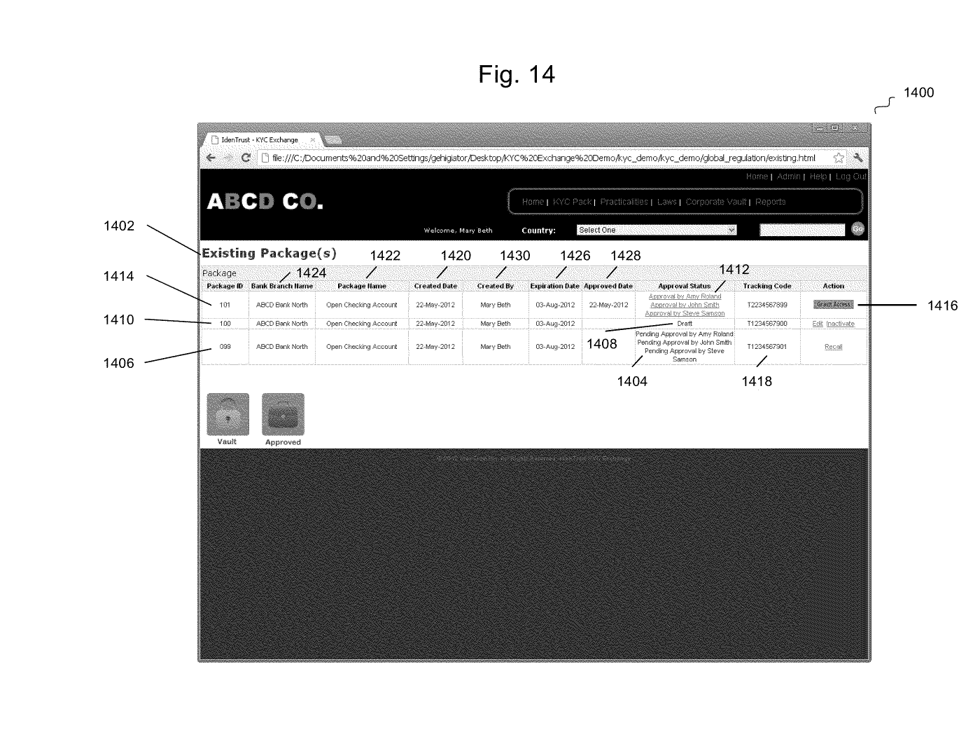

As shown in FIG. 14, existing KYC packages created by the user are listed 1402. Some may be pending packages 1404, such as package ID #099 1406; some may be saved drafts 1408, such as package ID #100 1410; and some may be approved packages 1412 that have been approved, such as package #101 1414.

If the KYC package has been approved, the KYC exchange server presents a “Grant Access” button 1416 to the user. Pressing the grant access button 1416 grants a branch access to the approved KYC package. Pending packages 1404 that have not been approved may be recalled if the user or the corporation decides to no longer pursue a relationship with a certain branch.

As shown in FIG. 14, a plurality of other information about the existing packages is presented, such as tracking code 1418, creation date 1420, package name 1422, branch name 1424, expiration date 1426, approval date 1428, and who created the package 1430.

Returning to FIG. 2, once the user clicks the grant access button, the selected branch is given access to the KYC package until the expiration date, if set, of the KYC package in step 224. After the branch is granted access, a notification is sent to the branch in step 226 notifying the branch that the KYC package is available for viewing. The branch logs into the KYC exchange server with a branch ID and digital certificate in step 226. In response to the branch logging into the KYC exchange server, the KYC exchange server prepares and displays the submitted KYC package submitted by the user in step 228. This step includes gathering all of the documents included in the KYC package from the database. In step 230, the financial institution can view the documents included in the KYC package from the database.

While the financial institution reviews the documents in the KYC package through the KYC exchange server, the user can monitor the financial institution's access in step 232.

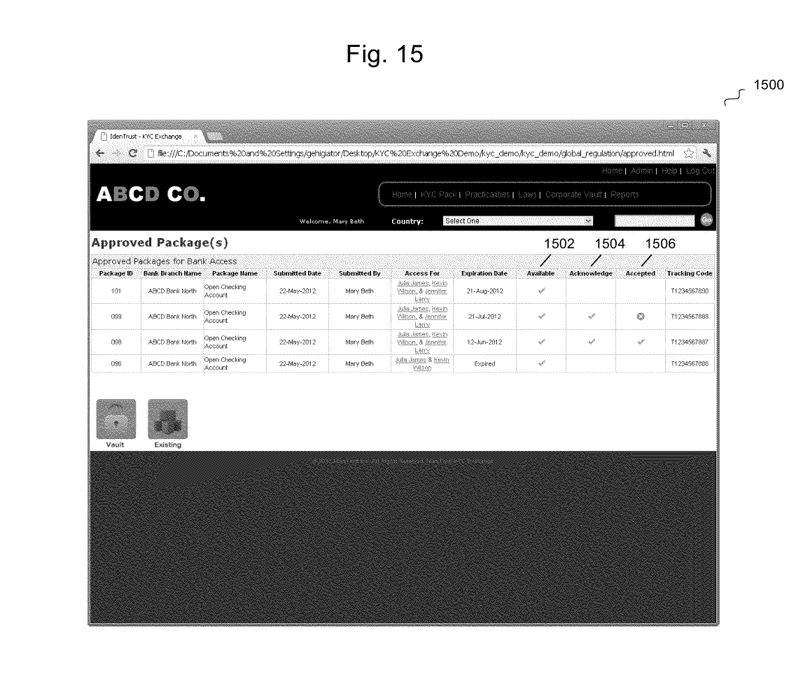

FIG. 15 illustrates an exemplary status monitoring webpage 1500 for approved and submitted KYC packages. Packages that are available to the financial institution 1502, packages that are acknowledged 1504 by the financial institution, and packages that have been accepted 1506 by the financial institution, are each displayed with a check mark.

Through the systems and methods described above, a corporation or an individual does not need to replicate documents every time they wish to create another financial relationship with a financial institution. The documents are also securely processed and submitted to a branch. Finally, the documents actually required for a country's KYC laws can be easily ascertained using the tools available through the KYC exchange server. With all of these advantages, individuals and corporations can more easily create financial relationships with financial institutions while still complying with KYC requirements.

Although the exemplary embodiment recites the use of financial information, it is intended that the exchange system described herein can be implemented in other industries that do not require KYC laws. For example, the exchange can be used for information involving pharmaceutical trials and exchanging documents during a trial review process. The exchange can be used in any instance where various types of information are stored in a secure location for access by multiple parties for varying reasons.

The above method can be implemented on a computer-implemented graphical user interface, whereby the user can interact with a server over a communication network, such as the internet. Although the exemplary embodiment uses a web browser with hyperlinks and linked buttons that can be selected by the user, it is intended that the graphical user interface can have any form with any type of selection mechanism for the user, including touch screen, menus, radio buttons, etc.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “calculating” or “determining” or “displaying” or “generating” or “synchronizing” or “outputting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A computer implemented method for initiating a financial service at a financial institution, the method comprising:
receiving, by a computer, a request from a client computer for a financial service associated with a financial institution, wherein the request comprises a selection of a country and a selection of the financial institution;
determining, by the computer, one or more know your customer (KYC) requirements associated with the selected financial institution;
determining, by the computer, one or more country requirements that are associated with the selected country;
determining, by the computer, whether a set at least one documents stored in a corporate vault memory satisfies the one or more KYC requirements, and whether the set of at least one documents satisfies the one or more country requirements;
calculating, by the computer, an extent to which the set of at least one documents satisfies the one or more KYC requirements and the one or more country requirements; and
presenting, by the computer, for each selected financial institution in each selected country, an indicator of the extent to which the at least one documents satisfies the one or more KYC requirements and the one or more country requirements.

2. The method according to claim 1, wherein the request further comprises a selection of a branch of the financial institution.

3. The method according to claim 1, wherein calculating the extent further comprises calculating a percentage of satisfied requirements.

4. The method according to claim 1, wherein the indicator is a score.

5. The method according to claim 1, further comprising:
determining, by the computer, whether any additional documents are needed to initiate the financial service with the financial institution based upon the extent to which the at least one document satisfies the one or more KYC requirements and the one or more country requirements.

6. The method according to claim 5, further comprising:
requesting, by the computer, at least one additional document when needed to initiate the financial service.

7. The method according to claim 6, further comprising:
receiving, by the computer, the at least one additional document needed to initiate the financial service; and
storing, by the computer, the at least one document in the corporate vault storage.

8. The method according to claim 7, further comprising:
generating, by the computer, a package for submission to the financial institution to initiate the financial service, wherein the package comprises at least one document from the corporate vault storage that satisfies the one or more KYC requirements and the one or more country requirements.

9. The method according to claim 8, further comprising:
authenticating, by the computer, a digital certificate received from the client computer; and
permitting, by the computer, the client computer access to the package only when the digital certificate is adequately authenticated.

10. The method according to claim 5, further comprising:
generating, by the computer, a prepopulated list of the at least one documents, wherein the computer determines whether any additional documents are needed using the prepopulated list of the at least one documents.

11. The method according to claim 8, further comprising:
updating, by the computer, the package to include at least one supplemental document.

12. The method according to claim 9, further comprising:
assigning, by the computer, expiration data to the package, wherein the expiration data rescinds permissions to view the package according to a predetermined condition.

13. The method according to claim 8, further comprising:
receiving, by the computer, a selection of one or more reviewers to approve the package.

14. The method according to claim 13, further comprising:
permitting, by the computer, the financial institution access to the package only when each reviewer approves the package using a digital signature.

15. The method according to claim 13, further comprising:
monitoring, by the computer, an approval status of the package; and
reporting, by the computer, the approval status to the client computer whenever a status request is received.

16. The method according to claim 8, further comprising:
assigning, by the computer, a tracking number to the package, wherein the approval status is monitored based on the tracking number.

17. The method according to claim 15, further comprising:
receiving, by the computer, a package recall request that rescinds access to the package from the client computer; and
terminating, by the computer, the review process based on the recall request.

18. The method according to claim 1, wherein before transmitting the package to the branch bank computer, the method further comprising:
authenticating, by the computer, the branch bank using a branch identifier and a digital certificate, wherein the package is only transmitted where the branch bank computer is adequately authenticated.

19. The method according to claim 1, wherein the set of documents in the corporate vault memory are reusable in a different package.

20. A system for preparing documents for a financial service comprising:
a know your customer (KYC) requirements repository storing one or more KYC requirements associated one or more financial institutions;
a country requirements repository storing one or more country requirements associated with one or more countries;
a corporate vault memory storing one or more packages and one or more documents, wherein each package comprises a set of one or more documents selected from the one or more documents stored in the corporate vault memory;
a client computer transmitting a request for a financial service associated with a package, wherein the request comprises a selection of a country and a selection of a financial institution;
an exchange server processor receiving the request and configured to calculate a completion score based on an extent to which the package satisfies the one or more KYC requirements associated with the selected financial institution and the one or more country requirements associated with the selected country, wherein the package is a complete package when the completion score indicates that the package satisfies all requirements.

21. The system according to claim 20, further comprising:
a financial institution server comprising a processor receiving a completion score notification from the exchange server processor indicating the completion score.

22. The system according to claim 21,
wherein the exchange server permits the financial institution server to access the package when the package is a complete package, and
wherein the financial institution server retrieves the complete package.

23. The system according to claim 20, wherein the client computer stores a new document into the corporate vault memory.

24. The system according to claim 23, wherein the KYC exchanger server updates the package based on the new document.

25. The system according to claim 20, wherein the exchange server automatically updates the country requirements repository according to one or more new country requirements.

26. The system according to claim 21, wherein the financial institution server stores a new business practice in the KYC practices repository.

27. The system according to claim 20, wherein the exchange server transmits a notification signal to the client computer when the package is a complete package.

28. The system according to claim 22, wherein the exchange server transmits a notification signal to the financial institution when the package is a complete package.

29. The system according to claim 20, further comprising:
an credentials memory storing one or more user credentials associated with one or more users and one or more entity credentials associated with one or more financial institutions; and

30. The system according to claim 29, further comprising:
an authentication processor authenticating a user based on the user credentials associated with the user, and authenticating a financial institution using the entity credentials associated with the financial institution.

31. The system according to claim 30, wherein the credentials memory stores one or more device credentials associated with one or more computing devices, and wherein each device only communicates with a second device using a secure protocol requiring authentication of each device according to the device credentials associated with each device.

32. The system according to claim 22, wherein the client computer associates an expiration date with the package, and wherein the exchange server rescinds access to the package after the expiration date.

33. The system according to claim 20, further comprising:
a package reviewer store storing one or more package reviewers, wherein the client computer transmits a selection of a set of one or more package reviewers, and
wherein the exchange server transmits a notification signal to the set of package reviewers and grants access to each package reviewer, wherein the package is an approved package after each of the reviewers indicates an approval for the package.

34. The system according to claim 33, wherein the package reviewer store stores one or more digital signatures associated with the one or more package reviewers, wherein a package reviewer applies a digital signature to the package to indicate approval.

35. The system according to claim 21, wherein the exchange server permits the financial institution server access to an approved package, and wherein the financial institution server retrieves the approved package.

36. The system according to claim 34, wherein the exchange server stores a package approval status, and updates the package approval status according to whether a reviewer digitally signed the package.
